(19) United States
(12) Patent Application Publication
(10) Pub. No.: US 2017/0118552 A1
(43) Pub. Date: Apr. 27, 2017

(54) Headphone Covers

(71) Applicant: Roy S White, Sunrise, FL (US)

(72) Inventor: Roy S White, Sunrise, FL (US)

(21) Appl. No.: 14/920,319

(22) Filed: Oct. 22, 2015

(51) Int. Cl. H04R 1/12; H04R 5/033

(52) U.S. Cl. CPC H04R 1/12; H04R 5/0335

(57) ABSTRACT

A headphone cover assembly that fits onto any of a variety of pre-existing headphones to protect the wearer from contacting the headphone and providing a clean, dry and comfortable surface against which the user's ears rest.

### BACKGROUND OF THE INVENTION

1. Field of the Invention

The present invention relates to headphones, and more particularly, to a removable covers for headphones.

2. Description of the Related Art

Several designs for headphone accessories have been designed in the past. None of them, however, includes a removable and replaceable cover affixable over the housings of headphones that are soft and comfortable yet are washable to be re-used.

The headphone covers can be effectively used with typical headphones. Headphones include variations of on the ear, over the ear and other designs. Headphones can produce audio signals and sound that are heard by the wearer or sound blocking protective ear muffs. Headphones will in most cases have a means to hold the headphones onto the wearer's ear such as an over the head band, clips or other securing means. A headphone housing is sometimes referred to as a cup or cans and in most cases contains the sound generating or sound deadening components that allow the primary functionality of the headphones. Headphones can have bilateral housings or housings only for one ear.

Other devices relating to the closest subject matter provide for a number of more or less complicated features that fail to solve the problem in an efficient and economical way. None of these patents suggest the novel features of the present invention.

### SUMMARY OF THE INVENTION

It is one of the main objects of the present invention to provide a more comfortable experience to a headphone user, particularly for those who regularly wear headphones for a long time. This is especially suited to those who use headphones commercially. For example, fleet dispatchers, police and fire operators and aircraft controllers and pilots would be well served with the present invention.

It is another object of this invention to provide a more sanitary headphone cover. This is due to the ability to remove the headphone cover from the headphone for washing or replacement.

It is still another object of the present invention to provide a way for one pair of headphones to be used at different times by different users. For example, a pair of headphones could be provided for an operator station at a fleet dispatch center. Operators on different shifts could use the same pair of headphones with their own personal headphone covers. This would improve the cleanliness of the headphones and provide increased peace of mind for each user.

An object of the present invention is to provide a headphone cover for use at the gym with on or over the ear headphones as well as for use with hearing protection, such as might be in a noisy environment. By way of example, ear muffs might be used on a noisy construction site, at a gun range or similar situation.

Another object of the present invention is to allow a single user of a pair of headphones to switch the headphone covers throughout the day. For example, some users may sweat and cause the headphones to become moist and uncomfortable. Having a spare set of headphone covers can provide relief with a dry and clean headphone cover replacement periodically exchanged during the day.

Another object of the present device is both to protect the wearer from contacting the headphones to keep the person clean and vice-versa to keep the headphones free from contamination from the human wearer.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 shows a perspective view of a pair of headphones with a version of headphone covers installed.

FIG. 2 shows a perspective view of an adaption of a headphone cover apart from a pair of headphones.

FIG. 3 shows a perspective view of a version of a headphone cover without an exposed drawstring and including an elastic band.

FIG. 4 is shows an elevation view of an example of headphone covers in use on headphones while being worn by a person.

### DETAILED DESCRIPTION OF THE PREFERRED EMBODIMENT

The subject device and method of use is sometimes referred to as the device, the invention, the headphone covers, machine or other similar terms. These terms may be used interchangeably as context requires and from use the intent becomes apparent. The masculine can sometimes refer to the feminine and neuter and vice versa. The plural may include the singular and singular the plural as appropriate from a fair and reasonable interpretation in the situation.

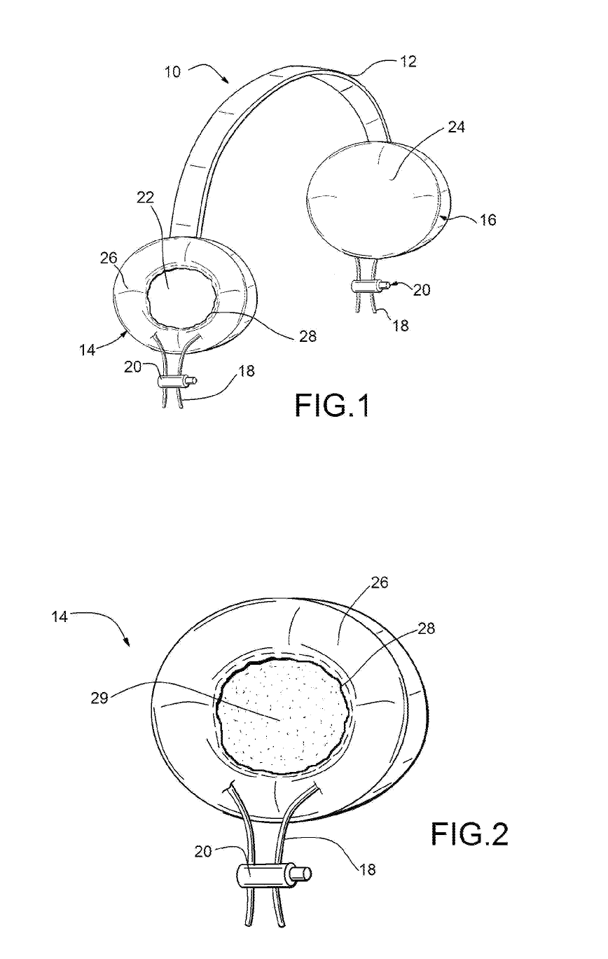

Referring now to the drawings, specifically FIG. 1, where a version of the present invention is shown with a pair of headphones as may be seen in typical use. It can be observed that it basically includes a headband 12, a cover assembly 14, a cover assembly 16, a drawstring 18, a toggle 20, a housing 22, a face 24, a rear 26, an edge 28 and an interior 29.

The underlying headphones include, among other features a band 12 connecting a housing 22 on one side containing a speaker to a housing on the opposing side also containing a speaker. The housing 22 is partially enclosed by the cover assembly 14. The complementary housing on the opposing side of the headband 12 is partially covered with the other cover assembly 16. Inside the housing 22 is a sound producing speaker and other sound related electrical components.

It should be understood that although the headphones shown in the drawings include a housing on each the left and right side, there are mono headphones with a housing on only one side. The present invention would work equally well with mono headphone when only one headphone cover is used at a time. The variations of the invention disclosed here are equally applicable to stereo or mono headphones.

In typical use a cover assembly 12 is placed over the housing 22 prior to putting on the headphones. Similarly the cover assembly 14 is placed over the other housing before use. The headphone headband 12 is then placed over the head of the user with the housings generally positioned over or on the ears of the wearer.

Looking now at FIGS. 1 and 2 where an important version of the invention is shown, the cover assembly 14 and cover assembly 16 are substantially copies of each other. Due to different parts of the design visible in different views, these figures and elements are to be read together. On one side of a cover assembly 14 (or equally cover assembly 16 because they are substantially identical) is a face 24 that comes into contact with the wearer's ears while in use. The rear 26 is on the opposing side of the cover assembly 14 (and cover assembly 16) is an opening bounded by an edge 28.

In typical use the rear 26 is away from the wearer's head and the housing 22 may be visible within the cover assembly 14 through the edge 28. The edge 28 may be hemmed to contain a drawstring 18. Alternatively, elastic could be sewn into the edge 28. The drawstring 18 could enter and exit from the hemmed edge 28 and be joined by a spring operated clip toggle 20. This will allow the cover assembly 14 to be pulled over the housing 22 of the headphone when the drawstring 18 is loosened. Once positioned over the housing 22 the drawstring 18 can be tightened and secured with the toggle 20.

Other closure means of the drawstring 18 could be equally effective. For example, a simple knot or any of a wide variety of commercially available clips or clasps could be used with substantially similar results to keep the cover assembly 14 onto the headphone housing 20.

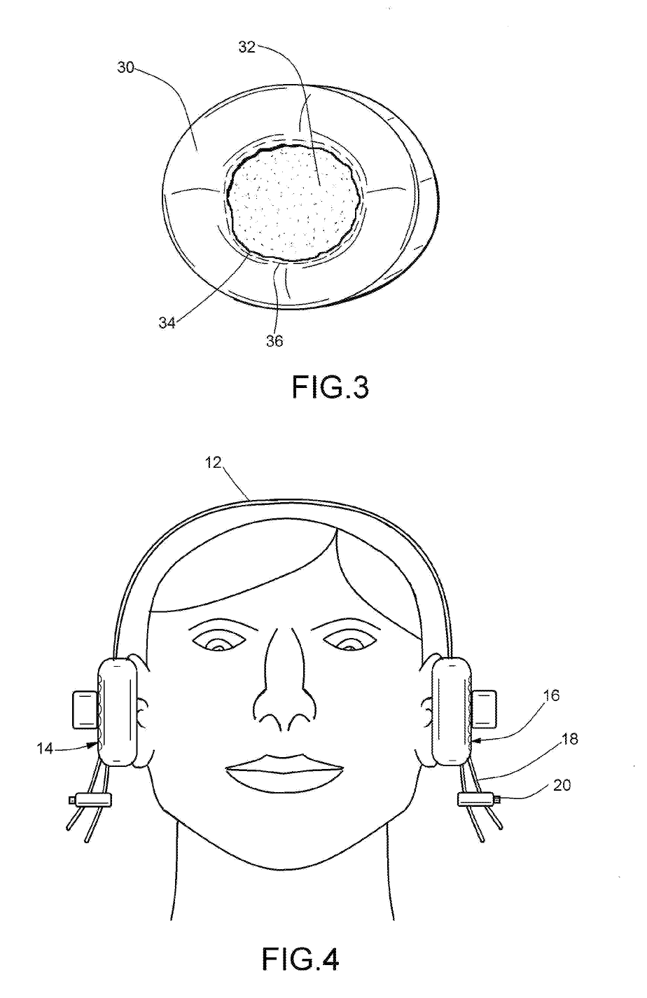

FIG. 3 demonstrates a cover assembly with, among other things, an alternate closure means that includes a rear 30, an interior 32, and edge 34 and a band 36. Some of the features of this version are similar to those found in versions described above. A distinction is the elastic band 36 integral to the edge 34.

In important distinction to the version of the earphone cover shown in FIG. 3 is the inclusion on an elastic band 36 fabricated into the edge 34 on the rear 30 surface. The band 36 can be sewn into the edge 34 or into a hem comprising the edge 34. Without being installed onto an earphone housing, the interior 32 of the cover assembly nearest the ear is visible. To install this version of the device over a headphone housing 22 the band 36 is stretched over the side of the housing 22 facing the wearer's ear so that the housing 22 is essentially inside of the earphone cover assembly.

FIG. 4 shows an example of how a headphone cover assembly in combination with a stereo headphone might be in actual use over the ears of a person. The headphones are positioned over the head in a typical fashion with the headphone cover assembly 14 and 16 over the housings of the headphone. The housings of the headphone do not come into contact with the user of the device.

It is preferred that the headphone covers are constructed of a soft and flexible material. Fabrics of many varieties have been found to be effective. For example, a cotton weave, knit or terry work well. Other materials and fabric blends also work well including polyester, spandex, elastic fabrics, natural or synthetic fibers and other known materials.

In an important version of the invention the materials from which the device is constructed are designed to survive washing so that they can be cleaned and re-used. Other versions are adapted to be disposable. Comfort of the wearer and durability are important considerations when selecting a fabric of manufacture.

In at least one version the headphone cover is made of a stretchy polyurethane fabric (for example a fabric commonly known as spandex) that can stretch to form fit over the headphone housing. Other materials that are known to be useful are, individually or combinations of, quick-dry, elastin, cotton blends, polyester and wicking fabrics.

Another version of the device uses a combination of fabrics to enhanced effect. A wicking material is placed in areas in contact with the wearer's skin and an absorbent layer is inside to keep the wearer's skin drier and therefore more comfortable. This can be particularly useful in extremely hot, sweaty environments or in cold, freezing environments for this reason.

The drawstring 18 can be constructed of common materials traditionally used for drawstrings in the garment industry. Alternatively, the drawstring 18 can be elastic itself. The drawstring could have a round, flat or elongated profile to enhance its ability to close around the backside of the housing 22, tie or engage into the toggle 20.

The headphone covers may be sold individually, in pairs or multi-packs depending on the application. They may be produced in a one-size-fits-most headphones dimension. Alternatively there may be class or model specific sizing available. They may be offered in a variety of colors, with designs and varying sizes to help snugly fit the housing.

An important version of the invention can be fairly described as a headphone cover comprised of cover dimensioned to fit substantially over a housing of a predetermined set of headphones to protect both the headphones and the wearer. The cover has on a first surface a soft and flexible face that contacts a wearer's ears. The cover has on a second surface away from the wearer's ears an opening bounded by an edge. The opening is adjustable to expand to fit over the housing and adjustable to contract to hold the headphone cover onto the housing. The first surface is constructed of a moisture wicking material and on an inside of the first surface is an absorbent layer that does not contact the wearer's ears thereby keeping the wearer's ears dry and comfortable. Optionally, the opening is adjustable by means of a drawstring inside a hem about a perimeter of the opening and the drawstring is fixed by a toggle, tie or other closure means. Alternatively, the opening is adjustable by means of an elastic band affixed about a perimeter of the opening or the device is made of an elastic material to snugly for over an earphone housing.

Another version of the device includes being constructed from an absorbent material that contacts the ears of the user. This is beneficial in removing sweat and moisture from the head that helps prevent the headphones from sliding and moving during typical use.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A headphone cover comprised of cover dimensioned to fit substantially over a housing of a predetermined set of headphones;
the cover has on a first surface a face that contacts a wearer's ears;
the cover has on a second surface an opening bounded by an edge;
the opening is adjustable to expand to fit over the housing and adjustable to contract to hold the headphone cover onto the housing;
the first surface is constructed of a moisture wicking material and on an inside of the first surface is an absorbent layer that does not contact the wearer's ears.

2. The headphone cover in claim 1 further characterized in that the opening is adjustable by means of a drawstring inside a hem about a perimeter of the opening and the drawstring is fixed by a toggle.

3. The headphone cover in claim 2 further characterized in that the drawstring is elastic.

4. The headphone cover in claim 1 further characterized in that the opening is adjustable by means of an elastic band affixed about a perimeter of the opening.

5. A headphone cover comprised of cover dimensioned to fit substantially over a housing of a predetermined set of headphones;
the cover has on a first surface a face that contacts a wearer's ears;
the cover has on a second surface an opening bounded by an edge;
the opening is adjustable to expand to fit over the housing, and adjustable to contract to hold the headphone cover onto the housing;
the first surface is constructed of a moisture wicking material and on an inside of the first surface is an absorbent layer that does not contact the wearer's ears;
the opening is adjustable by means of a drawstring inside a hem about a perimeter of the opening;
the drawstring is elastic.

6. The headphone cover in claim 5 further characterized in that the drawstring is fixed by a toggle.

7. A headphone cover comprised of cover dimensioned to fit substantially over a housing of a predetermined set of headphones;
the cover has on a first surface a face that contacts a wearer's ears;
the cover has on a second surface an opening bounded by an edge;
the opening is adjustable to expand to fit over the housing and adjustable to contract to hold the headphone cover onto the housing;
the first surface is constructed of an absorbent material that is in direct contact the wearer's ears.
